(19) United States
(12) Patent Application Publication
(10) Pub. No.: US 2018/0107421 A1
(43) Pub. Date: Apr. 19, 2018

(54) MULTI-SITE DUPLICATION VIA HIGH-LEVEL STORAGE UNIT PROCESSING MODULES

(71) Applicant: International Business Machines Corporation, Armonk, NY (US)

(72) Inventors: Asimuddin Kazi, Naperville, IL (US); Jason K. Resch, Chicago, IL (US)

(21) Appl. No.: 15/842,844

(22) Filed: Dec. 14, 2017

Related U.S. Application Data
(63) Continuation-in-part of application No. 15/642,875, filed on Jul. 6, 2017.
Application No. 15/642,875 is a continuation-in-part of application No. 14/869,240, filed on Sep. 29, 2015, now Pat. No. 9,727,275.
(60) Provisional application No. 62/086,542, filed on Dec. 2, 2014.

(51) Int. Cl. G06F 3/06; G06F 11/10

(52) U.S. Cl. CPC G06F 3/0641; G06F 3/0619; G06F 11/1076; G06F 3/067; G06F 3/064

(57) ABSTRACT

A method includes dispersed storage error encoding a data segment into a set of encoded data slices (EDSs), identifying a set of storage units (SUs) to store the set of EDSs, and identifying a number of sites where the set of SUs are located. The method further includes determining high level SU processing modules to engage at each site. The method further includes generating write requests regarding writing the set of EDSs to the set of SUs. The method further includes sending a first write request regarding a first subset of EDSs to the first high level SU processing module to facilitate storing the first subset of EDSs in a first subset of SUs and sending the second write request regarding the second subset of EDSs to the second high level SU processing module to facilitate storing the second subset of EDSs in a second subset of SUs.

### CROSS-REFERENCE TO RELATED APPLICATIONS

The present U.S. Utility Patent Application claims priority pursuant to 35 U.S.C. § 120 as a continuation-in-part of U.S. Utility application Ser. No. 15/642,875, entitled “PRIORITIZED DATA REBUILDING IN A DISPERSED STORAGE NETWORK,” filed Jul. 6, 2017, which claims priority pursuant to 35 U.S.C. § 120 as a continuation-in-part of U.S. Utility application Ser. No. 14/869,240, entitled “COORDINATING STORAGE OF DATA IN DISPERSED STORAGE NETWORKS,” filed Sep. 29, 2015, now issued as U.S. Pat. No. 9,727,275, which claims priority pursuant to 35 U.S.C. § 119(e) to U.S. Provisional Application No. 62/086,542, entitled “CONSISTENT STORAGE OF DATA IN A DISPERSED STORAGE NETWORK,” filed Dec. 2, 2014, all of which are hereby incorporated herein by reference in their entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer networks and more particularly to dispersing error encoded data.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

It is further known that disconnected memory devices of a dispersed storage system can result in significant data loss and slow processing times.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9A is a schematic block diagram of another embodiment of a dispersed or distributed storage network (DSN) in accordance with the present invention;

FIG. 9B is a flowchart illustrating an example of storing data in accordance with the present invention;

FIG. 10 is a schematic block diagram of another embodiment of a dispersed or distributed storage network (DSN) in accordance with the present invention; and

FIG. 11 is a logic diagram of an example of a method of multi-site duplication via high level storage unit processing modules in accordance with the present invention.

### DETAILED DESCRIPTION OF THE INVENTION

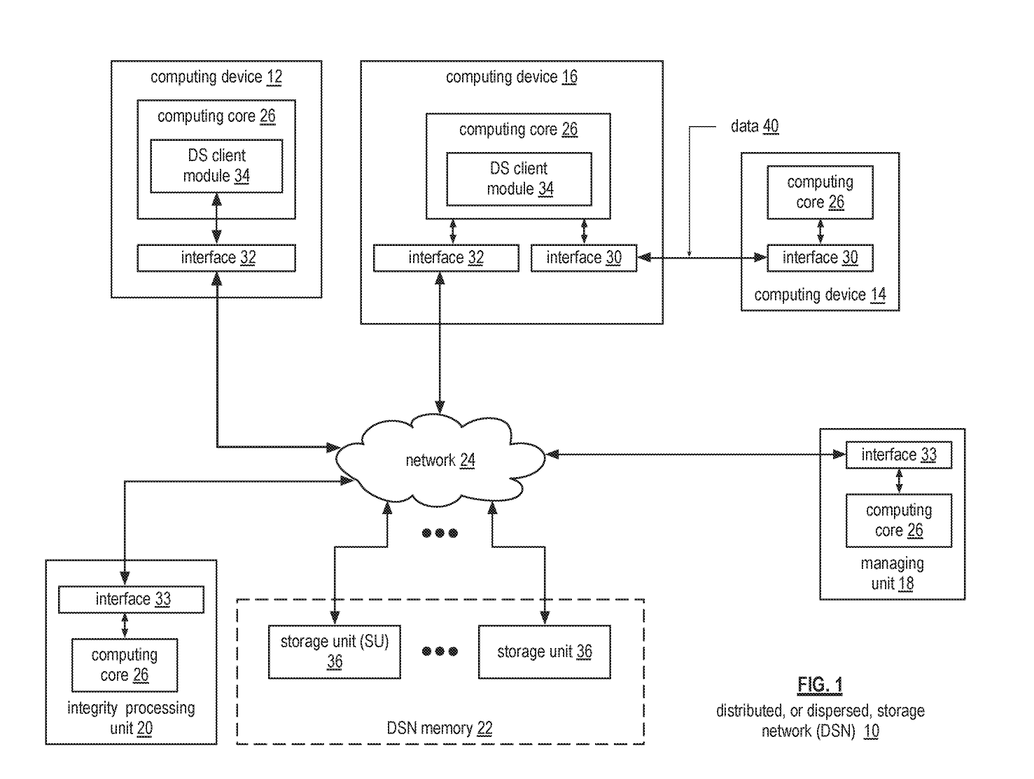

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

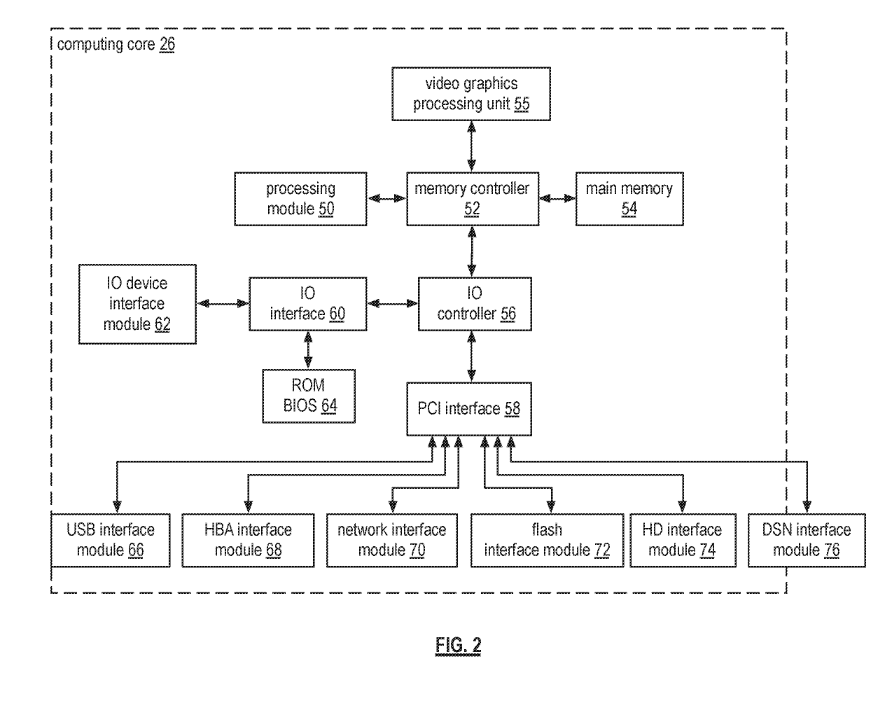

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

Computing devices 12 and 16 include a dispersed storage (DS) client module 34, which enables the computing device to dispersed storage error encode and decode data as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSN managing unit 18 tracks the number of times a user accesses a non-public vault and/or public vaults, which can be used to generate a per-access billing information. In another instance, the DSN managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

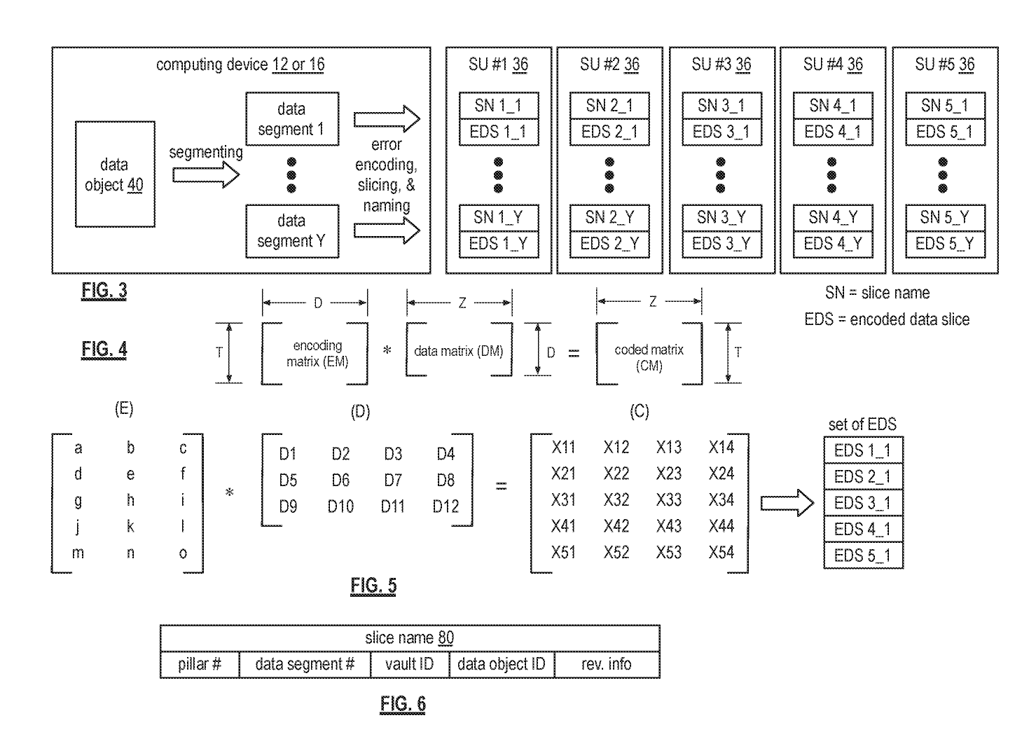

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 60 is shown in FIG. 6. As shown, the slice name (SN) 60 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5 Y.

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

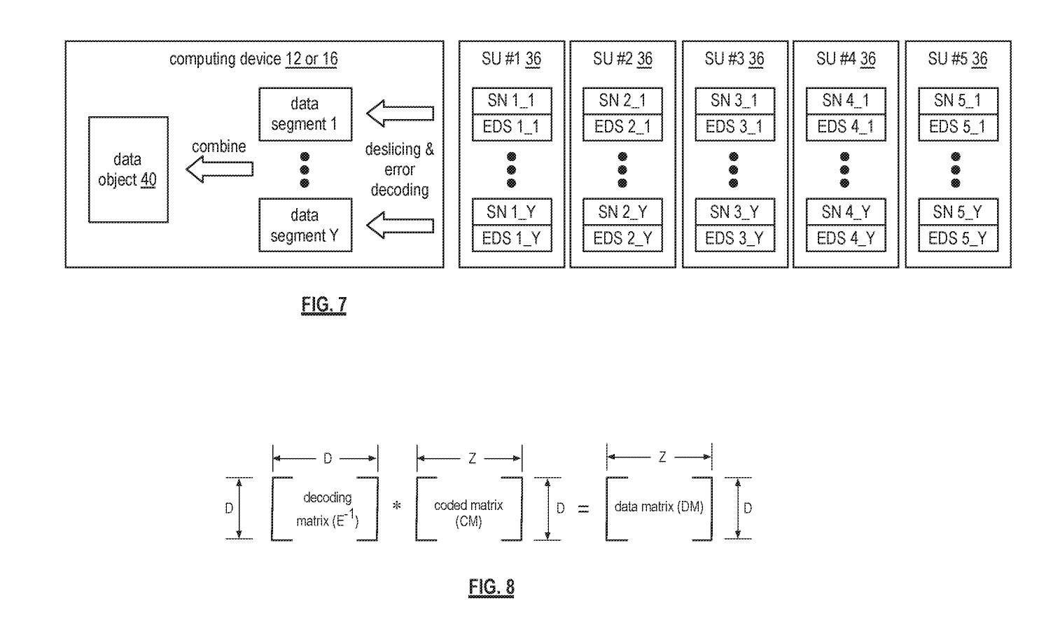

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

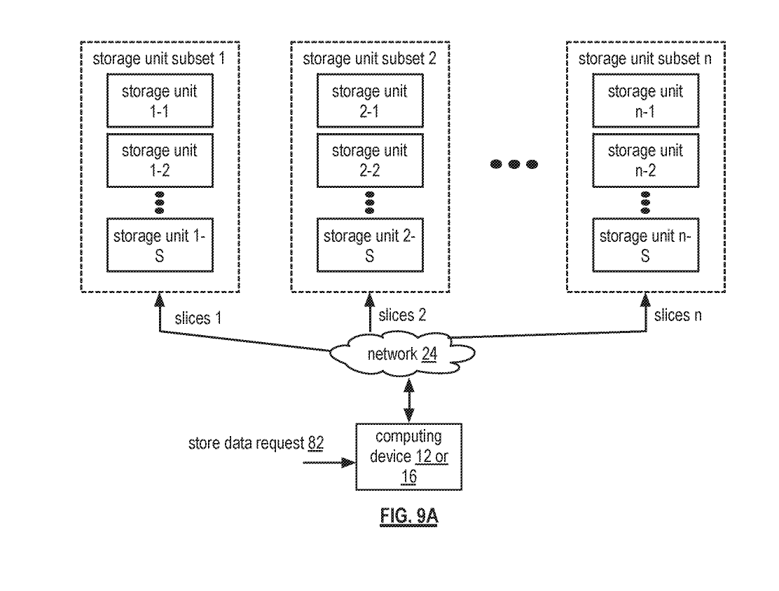

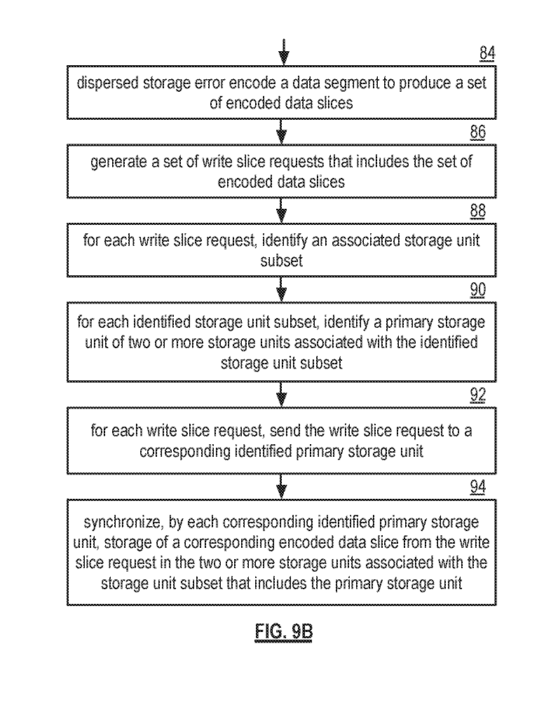

FIG. 9A is a schematic block diagram of another embodiment of a dispersed or distributed storage network (DSN) that includes a set of storage unit subsets 1-n, the network 24 of FIG. 1, and computing device 12 or 16 of FIG. 1. Each storage unit subset includes a subset of storage units 1-S. Each storage unit may be implemented utilizing storage unit 36 of FIG. 1.

The DSN functions to store data in at least some of the storage unit subsets 1-n, where the data is dispersed storage error encoded to produce a plurality of sets of encoded data slices for storage in the storage unit subsets 1-n. In an example of operation of the storing of the data, computing device 12 or 16 receives a store data request 82, where the store data request 82 includes one or more of the data, a data identifier, and a requesting entity identifier. Having received the data, computing device 12 or 16 dispersed storage error encodes the data to produce the plurality of sets of encoded data slices.

Having produced the plurality of sets of encoded data slices, computing device 12 or 16 generates at least one set of write slice requests, where the at least one set of write slice requests includes the plurality of sets of encoded data slices. For each storage unit subset, the computing device 12 or 16 identifies a storage unit to be associated with a subset slice access process. The identifying may be based on one or more of interpreting system registry information, initiating a query, interpreting a query response, utilizing a predetermination, and using an identifier of a request. For example, the computing device 12 or 16 identifies storage unit 1-2 of the storage unit subset 1, storage unit 2-5 of the storage unit subset 2, etc.

For each identified storage unit, computing device 12 or 16 sends, via the network 24, a corresponding write slice request of the at least one set of write slice requests to the identified storage unit. For example, the computing device 12 or 16 sends, via the network 24, a first write slice request to storage unit 1-2, where the request includes encoded data slice 1 of a first set of encoded data slices.

Each identified storage unit receiving a corresponding write slice request stores one or more encoded data slices of the received write slice request in a local memory associated with the identified storage unit. Each identified storage unit receiving the corresponding write slice request facilitates synchronization of storage of the one or more encoded data slices of the received write slice request amongst the local memory of the identified storage unit and remaining storage units of the storage unit subset. For example, storage unit 1-2 sends the one or more encoded data slices of the received write slice request to storage unit 1-1 through storage unit 1-S of the storage unit subset 1 for storage. From time to time, each of the storage units of a common storage unit subset facilitate maintaining synchronization of stored encoded data slices such that each of the storage units of the common storage unit subset story substantially all of the same encoded data slices.

The DSN further functions to retrieve the stored data from the storage unit subsets. In an example of operation, computing device 12 or 16 sends at least a decode threshold number of read slice requests to a read threshold number of the storage unit subsets. As a specific example, computing device 12 or 16 sends a first read slice request to the identified storage unit 1-2 at the storage unit subset 1. As another specific example, computing device 12 or 16 sends the first read slice request to any remaining storage unit of the storage unit subset 1. When a storage unit receives a read slice request, the storage unit determines whether an associated local memory of the storage unit stores a desired encoded data slice of the read slice request. The storage unit issues a read slice response to computing device 12 or 16 when the storage unit recovers the desired encoded data slice from the associate a local memory of the storage unit. Alternatively, the storage unit obtains the desired encoded data slice from another storage unit of a common storage unit subset and issues the read slice requests to computing device 12 or 16 utilizing the obtained encoded data slice. As another specific example, the storage unit forwards the read slice request to at least one other storage unit of the common storage unit subset when the storage unit determines that the desired encoded data slice is that stored in the local memory of the storage unit.

FIG. 9B is a flowchart illustrating an example of storing data. The method begins at step 84 where a processing module of one or more processing modules of one or more computing devices of a dispersed storage network (DSN) dispersed storage error encodes a data segment to produce a set of encoded data slices. For example, the processing module divides received data into a plurality of data segments that includes the data segment.

The method continues at step 86 where the processing module generates a set of write slice requests that includes the set of encoded data slices. For example, the processing module generates a set of slice names and generates the set of write slice requests to include the set of slice names and the set of encoded data slices.

For each write slice request, the method continues at step 88 where the processing module identifies an associated storage units' subset. The identifying includes at least one of interpreting a system registry, issuing a query, interpreting a query response, utilizing a predetermination, receiving a request, and interpreting a status message.

For each identified storage unit subset, the method continues at step 90 where the processing module identifies a primary storage unit of two or more storage units associated with the identified storage unit subset. The identifying includes at least one of interpreting a system registry, issuing a query, interpreting a query response, utilizing a predetermination, receiving a request, and interpreting a status message.

For each write slice request, the method continues at step 92 where the processing module sends the write slice request to a corresponding identified primary storage unit. The method continues at step 94 where each corresponding identified primary storage unit synchronizes storage of a corresponding encoded data slice from the write slice request in the two or more storage units associated with the storage unit subset that includes the primary storage unit. For example, the primary storage unit stores the encoded data slice in a local memory of the primary storage unit and issues write slice requests to remaining storage unit of the storage unit subset, where the write slice request includes copies of encoded data slice. From time to time, one or more of the storage units of the storage unit subset facilitate synchronization of stored encoded data slices among substantially all of the storage units of the storage unit subset.

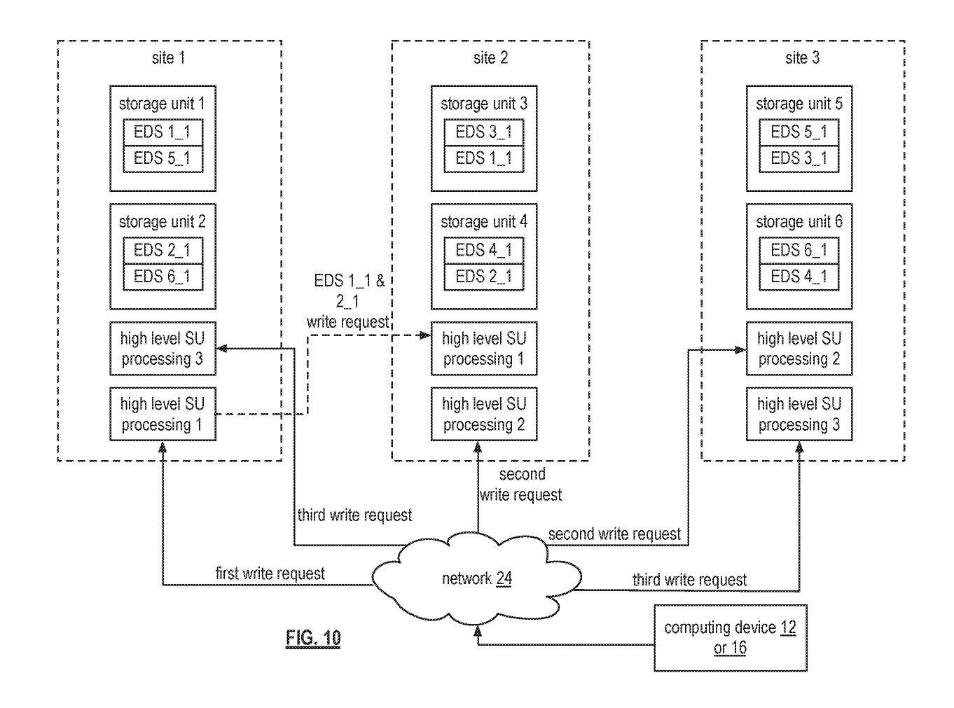

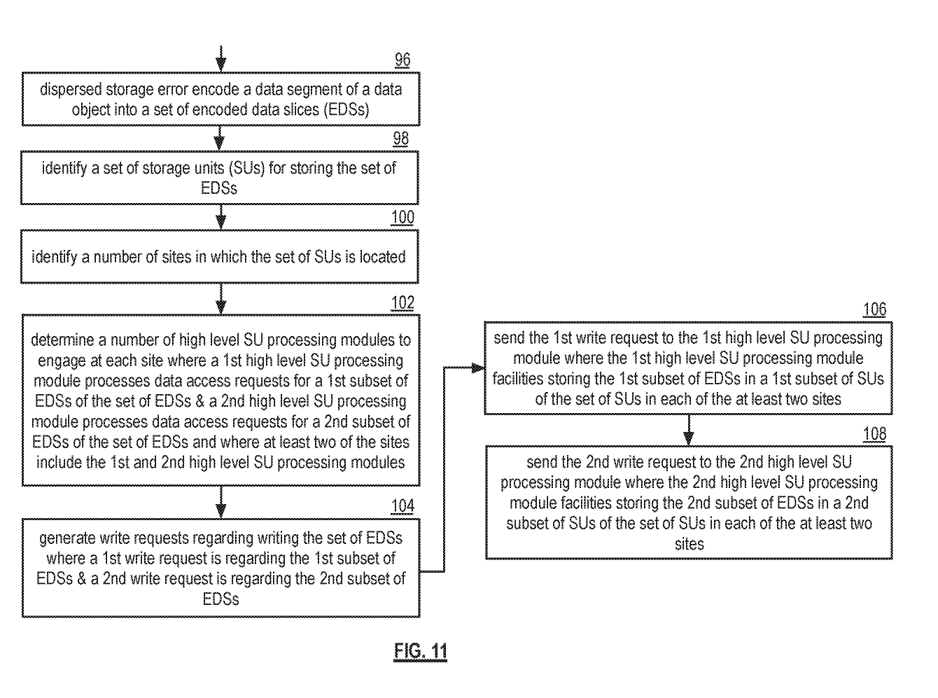

FIG. 10 is a schematic block diagram of another embodiment of a dispersed or distributed storage network (DSN) that includes computing device 12 or 16, network 24, and multiple sites (1-3) of a DSN memory. Sites 1-3 are each located at geographically different sites. Site 1 includes storage units 1-2 connected via local area network (LAN), site 2 includes storage units 3-4 connected via LAN, and site 3 includes storage units 5-6 connected via LAN.

Sites 1-3 further include high level storage unit (SU) processing modules to facilitate storage of encoded data slices within a site. The DSN is operable to track and/or periodically look for encoded data slices are not fully replicated across the set of storage units and attempt to achieve full synchronization when possible. In order to support full write/read operations at any disconnected site, a high level storage unit processing module may be virtualized as a process which can have multiple concurrent instantiations (e.g., instances of the same high level storage unit processing module exists in at least two sites). For example, site 1 includes high level storage unit processing modules 1 and 3, site 2 includes high level storage unit processing modules 1 and 2, and site 3 includes high level storage unit processing modules 2 and 3.

In an example of operation, computing device 12 or 16 dispersed storage error encodes a data segment of a data object into a set of encoded data slices (e.g. EDSs 1_1 through 6_1). Computing device 12 or 16 identifies a set of storage units for storing the set of encoded data slices and identifies a number of sites in which the set of storage units are located. For example, computing device 12 or 16 identifies storage units 1-6 within sites 1-3 for storing the set of encoded data slices.

Computing device 12 or 16 determines a number of high level storage unit processing modules to engage at each site of the number of sites. Determining the number of high level storage unit processing modules to engage is based on the total number of sites of the DSN, the number of storage units in each site of the total number of sites, and a desired level of reliability for the DSN. The desired level of reliability for the DSN is determined by a desired threshold number of encoded data slices of the set of encoded data slices to be stored at each site of the total number of sites while considering encoded data slice distribution balancing such that no one storage unit in any site of the total number of sites stores a decode threshold number of encoded data slices of the set of encoded data slices. The desired threshold number is a decode threshold number, a read threshold number, a write threshold number, or a full pillar width threshold number.

For example, computing device 12 or 16 determines to engage high level storage unit processing modules 1 and 3 at site 1, high level storage unit processing module 2 at site 2, and high level storage unit processing modules 2 and 3 at site 3. In this example, the desired threshold number of encoded data slices of the set of encoded data slices to be stored at each site is a write threshold number of 4 encoded data slices (e.g., if one site is disconnected, the other sites have a write threshold number of encoded data slices of the set of encoded data slices). The pillar width number is 6 and the decode threshold number is 3. Computing device 12 or 16 determines to engage high level storage unit processing modules 1 and 3 at site 1, high level storage unit processing module 2 at site 2, and high level storage unit processing modules 2 and 3 at site 3 because a write threshold number of encoded data slices can be stored on each site without encountering a storage unit storing a decode threshold number of encoded data slices (e.g., 3 encoded data slices stored on a storage unit).

High level storage unit processing module 1 processes data access requests for a first subset of encoded data slices of the set of encoded data slices (e.g., EDSs 1_1 and 2_1). High level storage unit processing module 2 processes data access requests for a second subset of encoded data slices of the set of encoded data slices (e.g., EDSs 3_1 and 4_1). High level storage unit processing module 3 processes data access requests for a third subset of encoded data slices of the set of encoded data slices (e.g., EDSs 5_1 and 6_1).

Computing device 12 or 16 generates write requests regarding writing the set of encoded data slices to the set of storage units. A first write request of the write requests is regarding the first subset of encoded data slices (e.g., EDSs 1_1 and 2_1). A second write request of the write requests is regarding the second subset of encoded data slices (e.g., EDSs 3_1 and 4_1). A third write request of the write requests is regarding the third subset of encoded data slices (e.g., EDSs 3_1 and 4_1). The first, second, and/or third write request may include individual write requests for each encoded data slice of the corresponding subset of encoded data slices. For example, the first write request includes a write request regarding writing EDS 1_1 and a write request regarding writing EDS 2_1.

Computing device 12 or 16 sends the first write request to high level storage unit processing module 1 in site 1. High level storage unit processing module 1 in site 1 facilitates storing EDS 1_1 and EDS 2_1 in storage units 1 and 2 of site 1. High level storage unit processing module 1 sends the first write request to the high level storage unit processing module 1 in site 2. High level storage unit processing module 1 in site 2 facilitates storing EDS 1_1 and EDS 2_1 in storage units 3 and 4 of site 2. Alternatively, computing device 12 or 16 sends the first write request to high level storage unit processing module 1 in site 2.

Computing device 12 or 16 sends the second write request to high level storage unit processing module 2 in sites 2 and 3. High level storage unit processing module 2 in site 2 facilitates storing EDS 3_1 and EDS 4_1 in storage units 3 and 4 of site 2. High level storage unit processing module 2 in site 3 facilitates storing EDS 3_1 and EDS 4_1 in storage units 5 and 6 of site 3. Computing device 12 or 16 sends the third write request to high level storage unit processing module 3 in sites 1 and 3. High level storage unit processing module 3 in site 1 facilitates storing EDS 5_1 and EDS 6_1 in storage units 1 and 2 of site 1. High level storage unit processing module 3 in site 3 facilitates storing EDS 5_1 and EDS 6_1 in storage units 5 and 6 of site 3.

FIG. 11 is a logic diagram of an example of a method of multi-site duplication via high level storage unit processing modules. The method begins with step 96 where a computing device of a dispersed storage network (DSN) dispersed storage error encodes a data segment of a data object into a set of encoded data slices. The method continues with step 98 where the computing device identifies a set of storage units for storing the set of encoded data slices. The method continues with step 100 where the computing device identifies a number of sites in which the set of storage units is located.

The method continues with step 102 where the computing device determines a number of high level storage unit processing modules to engage at each site of the number of sites. Determining the number of high level storage unit processing modules to engage is based on the total number of sites of the DSN, the number of storage units in each site of the total number of sites, and a desired level of reliability for the DSN. The desired level of reliability for the DSN is determined by a desired threshold number of encoded data slices of the set of encoded data slices to be stored at each site of the total number of sites while considering encoded data slice distribution balancing such that no one storage unit in any site of the total number of sites stores a decode threshold number of encoded data slices of the set of encoded data slices. The desired threshold number is a decode threshold number, a read threshold number, a write threshold number, or a full pillar width threshold number.

A first high level storage unit processing module processes data access requests for a first subset of encoded data slices of the set of encoded data slices and a second high level storage unit processing module processes data access requests for a second subset of encoded data slices of the set of encoded data slices. At least two of the sites of the number of sites include the first and second high level storage unit processing modules. When a third high level storage unit processing module processes data access requests for a third subset of encoded data slices of the set of encoded data slices, the at least two sites include two of the first, second, and third high level storage unit processing modules.

The method continues with step 104 where the computing device generates write requests regarding writing the set of encoded data slices to the set of storage units. A first write request of the write requests is regarding the first subset of encoded data slices and a second write request of the write requests is regarding the second subset of encoded data slices. A third write request of the write requests is regarding the third subset of encoded data slices. The first, second, and/or third write request may include individual write requests for each encoded data slice of the corresponding subset of encoded data slices.

The method continues with step 106 where the computing device sends the first write request to the first high level storage unit processing module. The first high level storage unit processing module facilitates storing the first subset of encoded data slices in a first subset of storage units of the set of storage units in each of the at least two sites. The first high level storage unit processing module sends the first write request to other instances of the first high level processing module in each site of the at least two sites. Alternatively, the computing device sends the first write request to other instances of the first high level storage unit processing module in other sites of the at least two sites.

The method continues with step 108 where the computing device sends the second write request to the second high level storage unit processing module. The second high level storage unit processing module facilitates storing the second subset of encoded data slices in a second subset of storage units of the set of storage units in each of the at least two sites. The second high level storage unit processing module sends the second write request to other instances of the second high level processing module in each site of the at least two sites. Alternatively, the computing device sends the second write request to other instances of the second high level storage unit processing module in other sites of the at least two sites.

The computing device sends the third write request to the third high level storage unit processing module. The third high level storage unit processing module facilitates storing the third subset of encoded data slices in a third subset of storage units of the set of storage units in each of the at least two sites. The third high level storage unit processing module sends the third write request to other instances of the third high level processing module in each site of the at least two sites. Alternatively, the computing device sends the third write request to other instances of the third high level storage unit processing module in other sites of the at least two sites.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprises:
dispersed storage error encoding, by a computing device of a dispersed storage network (DSN), a data segment of a data object into a set of encoded data slices;
identifying, by the computing device, a set of storage units for storing the set of encoded data slices;
identifying, by the computing device, a number of sites in which the set of storage units is located;
determining, by the computing device, a number of high level storage unit processing modules to engage at each site of the number of sites, wherein a first high level storage unit processing module processes data access requests for a first subset of encoded data slices of the set of encoded data slices, wherein a second high level storage unit processing module processes data access requests for a second subset of encoded data slices of the set of encoded data slices, and wherein at least two sites of the number of sites include the first and second high level storage unit processing modules;
generating, by the computing device, write requests regarding writing the set of encoded data slices to the set of storage units, wherein a first write request of the write requests is regarding the first subset of encoded data slices, and wherein a second write request of the write requests is regarding the second subset of encoded data slices;
sending, by the computing device, the first write request to the first high level storage unit processing module, wherein the first high level storage unit processing module facilitates storing the first subset of encoded data slices in a first subset of storage units of the set of storage units in each of the at least two sites; and
sending, by the computing device, the second write request to the second high level storage unit processing module, wherein the second high level storage unit processing module facilitates storing the second subset of encoded data slices in a second subset of storage units of the set of storage units in each of the at least two sites.

2. The method of claim 1, wherein the determining the number of high level storage unit processing modules to engage is based on:
determining, by the computing device, a total number of sites of the DSN;
determining, by the computing device, a number of storage units in each site of the total number of sites; and
determining, by the computing device, a desired level of reliability for the DSN.

3. The method of claim 2, wherein the determining the desired level of reliability for the DSN comprises:
determining, by the computing device, a desired threshold number of encoded data slices of the set of encoded data slices to be stored at each site of the total number of sites, wherein the desired threshold number is a decode threshold number, a read threshold number, a write threshold number, or a full pillar width threshold number; and
determining, by the computing device, encoded data slice distribution balancing such that no one storage unit in any site of the total number of sites stores a decode threshold number of encoded data slices of the set of encoded data slices.

4. The method of claim 1 further comprises:
determining, by the computing device, a third high level storage unit processing module to engage in the at least two sites, wherein the third high level storage unit processing module processes data access requests for a third subset of encoded data slices of the set of encoded data slices, and wherein the at least two sites include two of the first, second, and third high level storage unit processing modules;
generating, by the computing device, a third write request of the write requests regarding the third subset of encoded data slices; and
sending, by the computing device, the third write request to the third high level storage unit processing module, wherein the third high level storage unit processing module facilitates storing the third subset of encoded data slices in a third subset of storage units of the set of storage units in each of the at least two sites.

5. The method of claim 1, wherein the first write request includes individual write requests for each encoded data slice of the first subset of encoded data slices.

6. The method of claim 1, wherein the sending the first write request to the first high level storage unit processing module comprises:
sending, by the computing device, the first write request to other instances of the first high level storage unit processing module in each site of the at least two sites.

7. The method of claim 1, wherein the sending the first write request to the first high level storage unit processing module comprises:
sending, by the computing device, the first write request to one instance of the first high level storage unit processing module in one site of the at least two sites, wherein the one instance of the first high level storage unit processing module sends the first write request to other instances of the first high level storage unit processing module in other sites of the at least two sites.

8. A computing device of a dispersed storage network (DSN), the computing device comprises:
an interface;
memory; and
a processing module operably coupled to the memory and the interface, wherein the processing module is operable to:
dispersed storage error encode a data segment of a data object into a set of encoded data slices;
identify a set of storage units for storing the set of encoded data slices;
identify a number of sites in which the set of storage units is located;
determine a number of high level storage unit processing modules to engage at each site of the number of sites, wherein a first high level storage unit processing module processes data access requests for a first subset of encoded data slices of the set of encoded data slices, wherein a second high level storage unit processing module processes data access requests for a second subset of encoded data slices of the set of encoded data slices, and wherein at least two sites of the number of sites include the first and second high level storage unit processing modules;
generate write requests regarding writing the set of encoded data slices to the set of storage units, wherein a first write request of the write requests is regarding the first subset of encoded data slices, and wherein a second write request of the write requests is regarding the second subset of encoded data slices;
send the first write request to the first high level storage unit processing module, wherein the first high level storage unit processing module facilitates storing the first subset of encoded data slices in a first subset of storage units of the set of storage units in each of the at least two sites; and
send the second write request to the second high level storage unit processing module, wherein the second high level storage unit processing module facilitates storing the second subset of encoded data slices in a second subset of storage units of the set of storage units in each of the at least two sites.

9. The computing device of claim 8, wherein the processing module is operable to determine the number of high level storage unit processing modules to engage based on:
determining a total number of sites of the DSN;
determining a number of storage units in each site of the total number of sites; and
determining a desired level of reliability for the DSN.

10. The computing device of claim 9, wherein the processing module is operable to the determine the desired level of reliability for the DSN by:
determining a desired threshold number of encoded data slices of the set of encoded data slices to be stored at each site of the total number of sites, wherein the desired threshold number is a decode threshold number, a read threshold number, a write threshold number, or a full pillar width threshold number; and
determining encoded data slice distribution balancing such that no one storage unit in any site of the total number of sites stores a decode threshold number of encoded data slices of the set of encoded data slices.

11. The computing device of claim 9, wherein the processing module is further operable to:
determine a third high level storage unit processing module to engage in the at least two sites, wherein the third high level storage unit processing module processes data access requests for a third subset of encoded data slices of the set of encoded data slices, and wherein the at least two sites include two of the first, second, and third high level storage unit processing modules;
generate a third write request of the write requests regarding the third subset of encoded data slices; and
send the third write request to the third high level storage unit processing module, wherein the third high level storage unit processing module facilitates storing the third subset of encoded data slices in a third subset of storage units of the set of storage units in each of the at least two sites.

12. The computing device of claim 9, wherein the first write request includes individual write requests for each encoded data slice of the first subset of encoded data slices.

13. The computing device of claim 9, wherein the processing module is operable to send the first write request to the first high level storage unit processing module by:
sending the first write request to other instances of the first high level storage unit processing module in each site of the at least two sites.

14. The computing device of claim 9, wherein the processing module is operable to send the first write request to the first high level storage unit processing module by:
sending the first write request to one instance of the first high level storage unit processing module in one site of the at least two sites, wherein the one instance of the first high level storage unit processing module sends the first write request to other instances of the first high level storage unit processing module in other sites of the at least two sites.
